(19) United States
(12) Patent Application Publication
(10) Pub. No.: US 2026/0208782 A1
(43) Pub. Date: Jul. 23, 2026

(54) CONNECTING BASE, CARRYING DEVICE, AND CHILD CARRIER

(71) Applicant: Wonderland Switzerland AG, Steinhausen (CH)

(72) Inventor: Wanquan ZHU, Dongguan, Guangdong (CN)

(73) Assignee: Wonderland Switzerland AG, Steinhausen (CH)

(21) Appl. No.: 19/144,210

(22) PCT Filed: Dec. 29, 2023
(86) PCT No.: PCT/EP2023/087976

§ 371 Date: Jun. 27, 2025

(30) Foreign Application Priority Data
Dec. 30, 2022 (CN) 202211730591.9

(51) Int. Cl. B62B 9/26; B62B 7/06

(52) U.S. Cl. CPC B62B 9/26; B62B 7/06

(57) ABSTRACT

The present application discloses a connecting base, a carrying device, and a child carrier. The connecting base includes: a body; a locking member, a driving member and a retaining member mounted on the body. The locking member has a locked position and an unlocked position. The driving member is connected to the locking member, and is configured to drive the locking member to move from the locked position to the unlocked position. When the locking member moves to the unlocked position, the retaining member locks the driving member, to retain the locking member in the unlocked position.

### CROSS-REFERENCE TO RELATED APPLICATIONS

This application claims priority to China Patent Application No. 2022117305919, filed on Dec. 30, 2022, the content of which is hereby incorporated by reference in its entirety. TECHNICAL FIELD The present application relates to a connecting base, a carrying device, and a child carrier.

### BACKGROUND

Stroller usually includes a carry cot and a frame. The carry cot is generally removably mounted on the frame for easy storage. More specifically, a mounting base is mounted on the frame, and the mounting base is provided with a locking hole. A connecting base is mounted on the carry cot, and a locking member is provided in the connecting base. The connecting base is adapted to be inserted into and cooperate with the mounting base (which can also be called snap fit). The locking member is adapted to be inserted into and cooperate with a locking hole to reliably support the carry cot on the frame. The carry cot is further provided with an unlocking button. The unlocking button is used to drive the locking member to move out of the locking hole to facilitate the removal of the carry cot from the frame.

When it is necessary to remove the carry cot from the frame, a user needs to bend down and press the unlocking button with both hands to drive the locking member to move out of the locking hole. Then, the user keeps pressing the unlocking button with both hands while raising the carry cot upwards so that the carry cot can be separated from the frame. If the user accidentally releases the unlocking button before raising the carry cot from the frame, the locking member can easily be reinserted into the locking hole. In order to successfully remove the carry cot, the user needs to press the unlocking button again and raise the carry cot.

### SUMMARY

In an aspect, the present application provides a connecting base, including: a body; a locking member mounted on the body, the locking member having a locked position and an unlocked position; a driving member mounted on the body and connected to the locking member, and the driving member being configured to drive the locking member to move from the locked position to the unlocked position; and a retaining member mounted on the body. When the locking member moves to the unlocked position, the retaining member is configured to lock the driving member, so as to retain the locking member in the unlocked position.

In an embodiment, the retaining member is movably disposed on the body, and has an extended position and a retracted position. When the retaining member is in the retracted position, and the locking member moves from the locked position to the unlocked position, the retaining member is engaged with the driving member to lock the driving member. When the retaining member moves towards the extended position, the retaining member is disengaged from the driving member.

In an embodiment, the connecting base further includes a first reset member configured to drive the retaining member to move towards the extended position.

In an embodiment, the locking member is movable relative to the body between the locked position and the unlocked position. A moving direction of the locking member is parallel to a moving direction of the retaining member.

In an embodiment, the connecting base further includes a second reset member configured to drive the locking member to move towards the locked position.

In an embodiment, the connecting base further includes a third reset member. The third reset member is configured to drive the driving member to reset when the retaining member is disengaged from the driving member.

In an embodiment, the body includes a receiving cavity. The driving member is mounted in the receiving cavity. A cavity wall of the receiving cavity is provided with a first hole and a second hole. The retaining member is movably disposed in the first hole. The locking member is movably disposed in the second hole. A moving direction of the locking member is parallel to a moving direction of the retaining member, and is perpendicular to a moving direction of the driving member.

In an embodiment, a driven pin is mounted on the locking member. An axial direction of the driven pin, the moving direction of the locking member, and the moving direction of the driving member are perpendicular to one another. The driving member includes at least one driving slope. The driving slope abuts against the driven pin to drive the locking member to move from the locked position to the unlocked position by the driving slope abutting against the driven pin.

In an embodiment, the driving member has a frame-shaped structure. The retaining member and the locking member are located in the frame-shaped structure. The frame-shaped structure includes two opposite side plates. Each side plate is provided with a driving hole. The driving slope is formed on a hole wall of each driving hole.

In an embodiment, the driving member includes a bearing portion extending out of the receiving cavity.

In an embodiment, the retaining member is provided with a stopper located in the receiving cavity.

In an embodiment, a moving direction of the retaining member is perpendicular to a moving direction of the driving member. The retaining member includes at least one first engaging portion. The driving member includes at least one second engaging portion. When the retaining member is in the retracted position and the locking member is in the locked position, each of the at least one first engaging portion moves onto a moving path of the corresponding second engaging portion.

In an embodiment, when the retaining member is in the retracted position and the driving member drives the locking member to move towards the unlocked position, each of the at least one second engaging portion passes over the corresponding first engaging portion and then is engaged with the first engaging portion.

In an embodiment, when the retaining member moves from the retracted position to the extended position, each of the at least one first engaging portion moves out of the moving path of the corresponding second engaging portion.

In an embodiment, the driving member includes two opposite side plates. The at least one second engaging portion is provided on each side plate. The retaining member is located between the two side plates. The retaining member includes at least two first engaging portions. One of the at least two first engaging portions is engaged with the second engaging portion on one of the two side plates, and the other one of the at least two first engaging portions is engaged with the second engaging portion on the other of the two side plates.

In an embodiment, the retaining member includes at least one first elastic arm; and the at least one first engaging portion is disposed on the at least one first elastic arm.

In an embodiment, the driving member includes at least one second elastic arm; and the at least one second engaging portion is disposed on the at least one second elastic arm.

In another aspect, the present application provides a carrying device, including the connecting base as described above.

In an embodiment, the carrying device further includes: a pulling member; and an unlocking button connected to the driving member through the pulling member.

In an embodiment, the carrying device further includes: an upper frame; a lower frame; and a foldable mechanism connected between the upper frame and the lower frame. The foldable mechanism is capable of being unfolded to enable the upper frame and the lower frame to move away from each other. The foldable mechanism is capable of being folded to enable the upper frame and the lower frame to approach each other.

In an embodiment, the foldable mechanism includes: a first upper bracket, an upper end of the first upper bracket being connected to the upper frame, and a lower end of the first upper bracket comprising two first lugs; a first lower bracket, an upper end of the first lower bracket comprising a second lug located between the two first lugs, and a lower end of the first lower bracket being pivotally connected to the lower frame; and a first pivot shaft extending through the first lugs and the second lug to enable the first upper bracket to be pivotally connected to the first lower bracket.

In yet another aspect, the present application provides a child carrier, including: a main frame including a mounting base; and the carrying device as described above. The mounting base is removably connected to the connecting base. The mounting base is provided with a locking hole corresponding to the locking member.

### BRIEF DESCRIPTION OF THE DRAWINGS

The drawings forming a part of this application are used to provide a further understanding of the present application. The illustrative embodiments of the present application and their descriptions are used to explain the present application and do not constitute an improper limitation of the present application.

FIG. 1 is a perspective view of a child carrier according to an embodiment of the present application.

FIG. 2 is a perspective view of the carrying device in FIG. 1.

FIG. 3 is an exploded view of the connecting base in FIG. 2.

FIG. 4 is a front view of the carrying device shown in FIG. 2.

FIG. 5 is an enlarged cross-sectional view of portion A in FIG. 4.

FIG. 6 is a partial cross-sectional view taken along a line B-B in FIG. 4, with a locking member in a locked position and a retaining member in an extended position.

FIG. 7 is a partial cross-sectional view taken along a line C-C in FIG. 4, with the locking member in the locked position and the retaining member in the extended position.

FIG. 8 is a rear view of the connecting base in FIG. 2, with a cover plate being omitted for ease of illustration of an internal structure of the connecting base, in which the locking member is in the locked position and the retaining member is in the extended position, a driving member is in an initial position.

FIG. 9 is a partial cross-sectional view taken along a line C-C in FIG. 4, with the locking member in the locked position and the retaining member in a retracted position.

FIG. 10 is a rear view of the connecting base in FIG. 2, with a cover plate being omitted for ease of illustration of an internal structure of the connecting base, in which the locking member is in the locked position, the retaining member is in the retracted position, and the driving member is in the initial position;

FIG. 11 is a partial cross-sectional view taken along a line D-D in FIG. 4, with the locking member in the locked position and the retaining member in a retracted position.

FIG. 12 is a rear view of the connecting base in FIG. 4, with a cover plate being omitted for ease of illustration of an internal structure of the connecting base, in which the locking member is in un unlocked position, the retaining member is in the retracted position, and the driving member is in a position locked by the retaining member.

FIG. 13 is a cross-sectional perspective view taken along a line C-C in FIG. 4, with the locking member is in the unlocked position, and the retaining member is in the retracted position.

FIG. 14 is a perspective view of the driving member according to another embodiment.

FIG. 15 is a cross-sectional perspective view taken along a line E-E in FIG. 4.

FIG. 16 is a cross-sectional perspective view taken along a line F-F in FIG. 15.

### DETAILED DESCRIPTION OF THE EMBODIMENTS

Embodiments of the invention are described more fully hereinafter with reference to the accompanying drawings. The various embodiments of the invention may, however, be embodied in many different forms and should not be construed as limited to the embodiments set forth herein. Rather, these embodiments are provided so that this disclosure will be thorough and complete, and will fully convey the scope of the invention to those skilled in the art. Elements that are identified using the same or similar reference characters refer to the same or similar elements.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element is referred to as being “connected” or “coupled” to another element, it can be directly connected or coupled to the other element or intervening elements may be present. In contrast, if an element is referred to as being “directly connected” or “directly coupled” to another element, there are no intervening elements present.

It will be understood that, although the terms first, second, etc. may be used herein to describe various elements, these elements should not be limited by these terms. These terms are only used to distinguish one element from another. Thus, a first element could be termed a second element without departing from the teachings of the present invention.

It should be noted that unless otherwise expressly specified and defined, terms “front”, “rear”, “left”, “right” and other orientation terms in the embodiments of the present application are based on the “front”, “rear”, “left”, “right” orientations of the child carrier when being normally used, and in the figures, the arrows H and P are used to schematically show the “front” and “rear” directions, and the arrows L and R are used to schematically show the “left” and “right” directions. These orientation terms are only used to make the description of the embodiments of the present application clearer and are not used to unduly limit the protection scope of the present application.

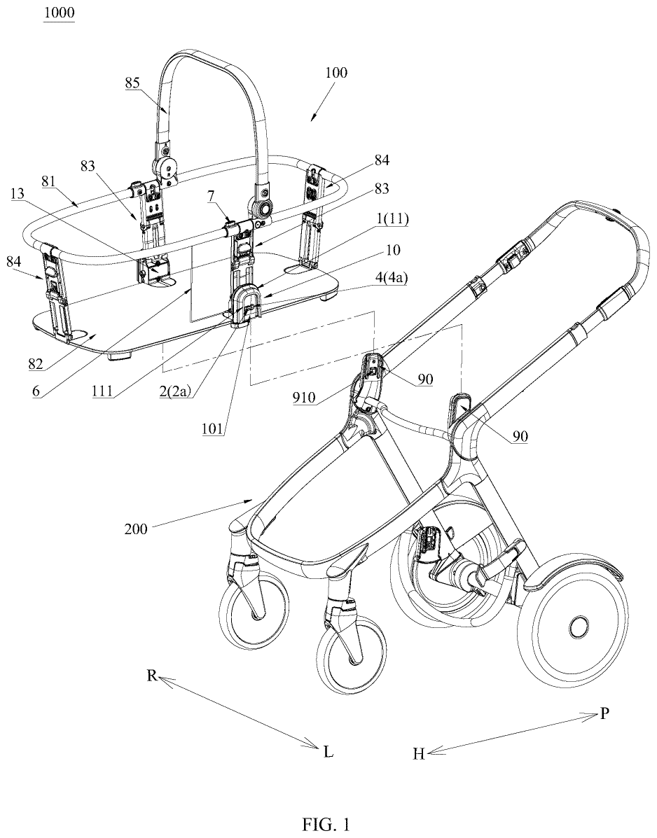

FIG. 1 schematically shows a child carrier 1000 according to an embodiment of the present application. The child carrier 1000 includes a main frame 200 and a carrying device 100 according to an embodiment of the present application. The main frame 200 can be supported by the ground and is configured to support the carrying device 100. The main frame 200 includes a mounting base 90. The carrying device 100 includes a connecting base 10 according to an embodiment of the present application. The connecting base 10 is removably connected to (for example, in a removable snap fit with) the mounting base 90, so that the carrying device 100 is removably connected to the main frame 200. In the embodiment of the present application, the child carrier 1000 is specifically described by taking a stroller as an example. The main frame 200 is specifically a frame of the stroller, and the carrying device 100 may be a carry cot, a stroller seat, or a baby carrier, etc. In some alternative embodiments, the type of the child carrier 1000 is not limited to the stroller shown in the figures. For example, the child carrier 1000 may be a child high chair or other child products. It can be understood that the types of the main frame 200 and the carrying device 100 are arranged according to the specific type of the child carrier 1000. In addition, the application range of the connecting base 10 according to the embodiment of the present application is not limited to the carrying device 100, and the application range of the carrying device 100 is not limited to the child carrier 1000. The connecting base 10 and the carrying device 100 can be applied in any suitable product.

Referring to FIG. 1, in some embodiments, the main frame 200 has a basically symmetrical structure, and the carrying device 100 also has basically symmetrical structure. Two mounting bases 90 are disposed on the left and right sides of the main frame 200, respectively, and two connecting bases 10 are disposed on the left and right sides of the carrying device 100, respectively. Each of mounting base 90 is connected to the corresponding connecting base 10. The mounting base 90 is provided with a locking hole 910 configured to cooperate with a locking member 2 of the connecting base 10.

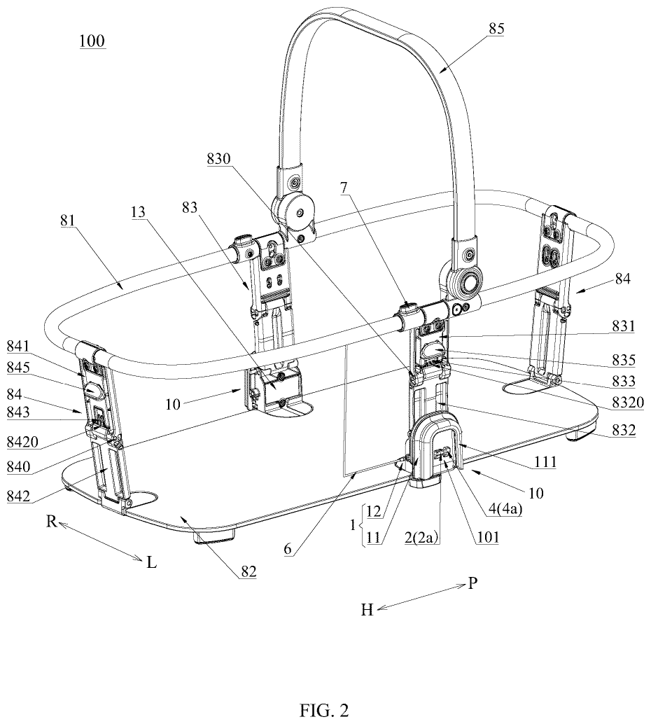

Referring to FIGS. 1 and 2, the carrying device 100 in the form of a carry cot includes an upper frame 81, a lower frame 82, a first foldable mechanism 83, a second foldable mechanism 84, and a handle 85. The upper frame 81 can be enclosed by a plurality of tubes. The handle 85 is mounted on the upper frame 81. The lower frame 82 may be a plate made of wood or plastic, etc. The left and right sides of the upper frame 81 are connected to the left and right sides of the lower frame 82 by the first foldable mechanisms 83, respectively. The front and rear sides of the upper frame 81 are connected to the front and rear sides of the lower frame 82 by the second foldable mechanisms 84, respectively. Therefore, the upper frame 81, the lower frame 82, the unfolded first foldable mechanism 83, and unfolded second foldable mechanism 84 together enclose a living space for a child. In practical applications, the sides and bottom of the living space enclosed by the upper frame 81 and the lower frame 82 can be wrapped with seat cloth, and a mat may be disposed on the lower frame 82. When it is necessary to store the carrying device 100, the first foldable mechanism 83 and the second foldable mechanism 84 can be folded, thereby reducing the distance between the upper frame 81 and the lower frame 82 and reducing the volume of the carrying device 100. Exemplary structures of the first foldable mechanism 83 and the second foldable mechanism 84 will be described below.

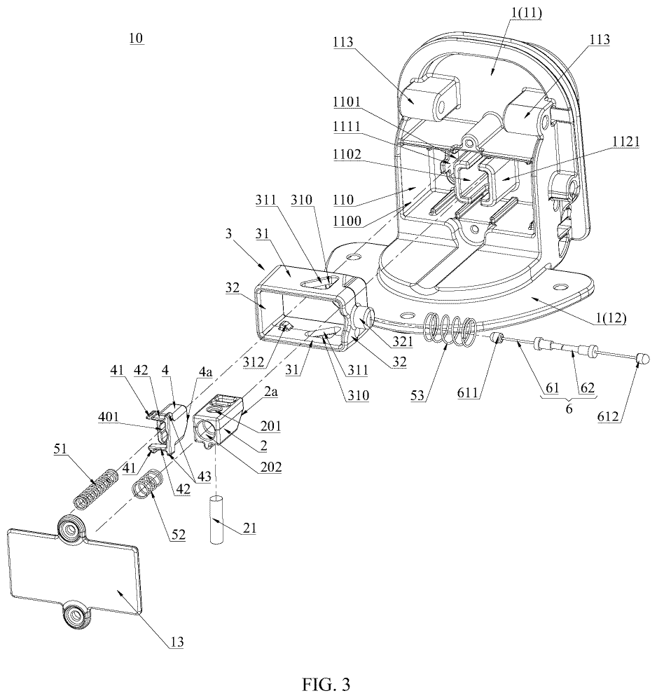

Referring to FIGS. 2 and 3, the carrying device 100 according to the embodiment of the present application is provided with two connecting bases 10 on both sides. Each of the connecting bases 10 is mounted on the lower frame 82, and is connected to the corresponding mounting base 90. The carrying device 100 has a substantially symmetrical structure. The configuration of the connecting base 10 will be described in detail below, taking the connecting base 10 on the left as an example.

Referring to FIGS. 2 and 3, the connecting base 10 includes a body 1, and a locking member 2, a driving member 3, and a retaining member 4 that are mounted on the body 1. In some embodiments, the body 1 may include a vertical portion 11 and a horizontal portion 12. The vertical portion 11 is connected to the mounting base 90, and the horizontal portion 12 is connected to the lower frame 82. In some embodiments, a flange 111 is disposed on the side of the vertical portion 11 facing the mounting base 90. The flange 111 encloses a first slot 101. The mounting base 90 can be insert into the first slot 101 from the bottom of the first slot 101. The configuration of the body 1 is not limited to the above examples.

Referring to FIG. 2, in some embodiments, the locking member 2 is movably disposed at the vertical portion 11 of the body 1. The locking member 2 has a locked position and an unlocked position. When the locking member 2 is in the locked position, the locking member 2 can be inserted into a locking hole 910 of the mounting base 90, thereby locking the relative position of the connecting base 10 and the mounting base 90. When the locking member 2 is in the unlocked position, the locking member 2 is completely withdrawn from the locking hole 910, and in this case, the connecting base 10 can be separated from the mounting base 90.

Referring to FIGS. 2 and 3, in some embodiments, the vertical portion 11 includes a receiving cavity 110. The receiving cavity 110 includes an opening 1100 facing the connecting base 10 on the right side. The opening 1100 can be closed by a cover plate 13. The cover plate 13 can be mounted on the vertical portion 11 through fasteners. A cavity wall of the receiving cavity 110 is provided with a second hole 1102. The second hole 1102 is in communication with the first slot 101. The locking member 2 enters the receiving cavity 110 through the opening 1100, and the locking member 2 is movably inserted in the second hole 1102. When the locking member 2 is in the locked position, a locking tongue end 2a of the locking member 2 protrudes into the first slot 101 relative to the second hole 1102 to be inserted into the locking hole 910 of the mounting base 90. When the locking member 2 is in the unlocked position, the locking tongue end 2a of the locking member 2 retracts into the second hole 1102, and the locking member 2 is separated from the locking hole 910. In some embodiments, a second channel wall 1121 is disposed in the receiving cavity 110. The second channel wall 1121 is in slide fit with the locking member 2. The second channel wall 1121 supports the locking member 2 while guiding the extending and retracting of the locking member 2.

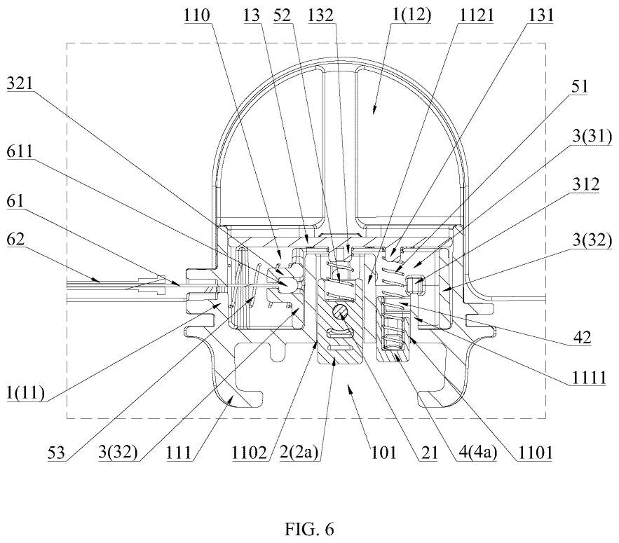

Referring to FIG. 3, the connecting base 10 can further be provided with a second reset member 52. The second reset member 52 is configured to drive the locking member 2 to move to the locked position. In some embodiments, the second reset member 52 may be, for example, a spring mounted in the receiving cavity 110. The second reset member 52 may be clamped between the locking member 2 and the cover plate 13. In order to facilitate the positioning of the second reset member 52, the locking member 2 is provided with a positioning hole 202, and the cover plate 13 is provided with a positioning post 132 (see FIG. 6). One end of the second reset member 52 extends into the positioning hole 202, and the other end of the second reset member 52 is sleeved on the positioning post 132. In some alternative embodiments, the second reset member 52 can be implemented in many ways, as long as it can directly or indirectly act on the locking member 2 to exert a force on the locking member 2 to move the locking member 2 towards the locked position.

Referring to FIG. 3, the driving member 3 is operatively connected to the locking member 2 and is configured to drive the locking member 2 to move from the locked position to the unlocked position. In some embodiments, the driving member 3 is mounted in the receiving cavity 110 through the opening 1100. The driving member 3 abuts against the locking member 2. The driving member 3 can move in the receiving cavity 110 when being pressed, thereby pushing the locking member 2 to move from the locked position to the unlocked position. In some embodiments, a moving direction of the driving member 3 is perpendicular to a moving direction of the locking member 2. Any suitable conversion mechanism may be provided between the driving member 3 and the locking member 2, as long as the movement of the driving member 3 can be converted into the movement of the locking member 2.

FIG. 3 shows exemplary structures of the driving member 3 and the locking member 2. The driving member 3 has a frame-shaped structure, which includes two opposite first side plates 31 and two second side plates 32 connected between the two first side plates 31. Each of the first side plate 31 is provided with a driving hole 310. A hole wall of each driving hole 310 is formed with at least one driving slope 311. For example, a bearing portion 321 is disposed on one of the second side plates 32. An external force may exert an unlocking force on the driving member 3 through the bearing portion 321. The locking member 2 is located in a frame-shaped structure. A driven pin 21 is mounted in a through hole 201 of the locking member 2. An axial direction of the driven pin 21 is perpendicular to both the moving direction of the locking member 2 and the moving direction of the driving member 3. Both ends of the driven pin 21 extend into the driving holes 310 of the two first side plates 31 respectively, and abut against the driving slopes 311 respectively. When an external force exerts the unlocking force on the bearing portion 321, while the driving member 3 moves in the receiving cavity 110, the driving slope 311 pushes the driven pin 21 to drive the locking member 2 to move to the unlocked position. The implementations of the driving member 3 and the locking member 2 is not limited to the above examples, as long as the driving member 3 can drive the locking member 2 to move from the locked position to the unlocked position.

Continuing to refer to FIG. 3, in some embodiments, the connecting base 10 can further be provided with a third reset member 53. When the external force driving the movement of the driving member 3 is removed, the third reset member 53 can reset the driving member 3. When the driving member 3 is reset, the locking member 2 can move to the locked position under the action of the second reset member 52. In some embodiments, the third reset member 53 may be, for example, a spring mounted in the receiving cavity 110, and the third reset member 53 is clamped between the cavity wall of the receiving cavity 110 and the second side plate 32 (see FIG. 6). In some alternative embodiments, the third reset member 53 can be implemented in many ways, as long as it can directly or indirectly act on the driving member 3 to reset the driving member 3.

It should be noted that in some alternative embodiments, when the third reset member 53 resets the driving member 3, the driving member 3 can drive the locking member 2 to move towards the locked position. Alternatively, when the second reset member 52 drives the locking member 2 to move towards the locked position, the locking member 2 can drive the driving member 3 to reset. In this case, one of the second reset member 52 and the third reset member 53 can be omitted.

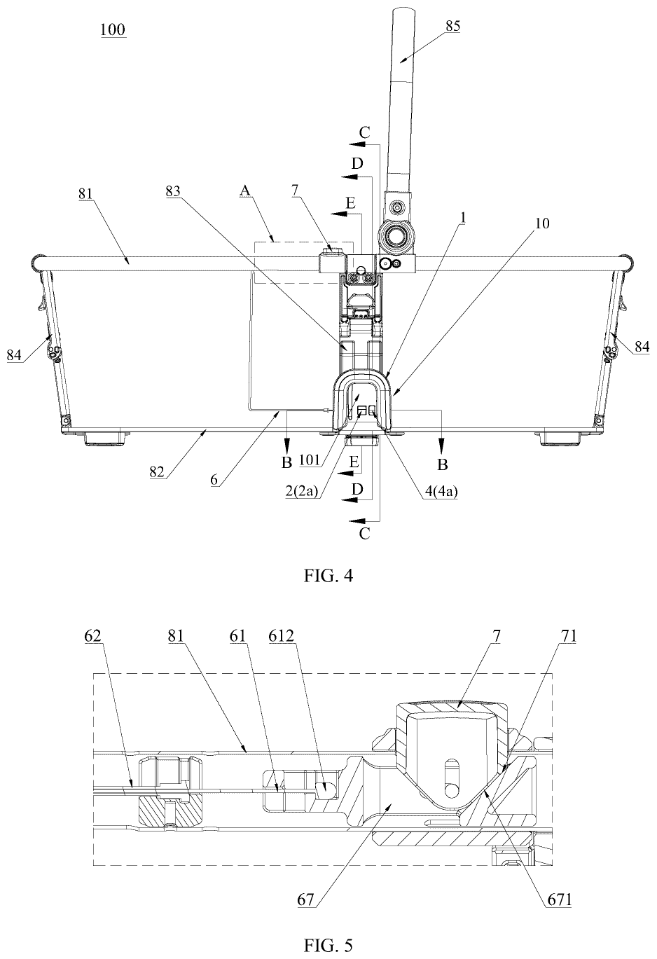

Referring to FIGS. 4 to 6, an exemplary structure configured for applying the external force to the driving member 3 is shown. In some embodiments, the carrying device 100 may further be provided with a pulling member 6 and an unlocking button 7. The pulling member 6 includes a rope 61 and a protective layer 62 wrapping an outside of the rope 61. A first end 611 of the rope 61 is connected to the bearing portion 321 of the driving member 3, and a second end 612 of the rope 61 is connected to a slider 67. The slider 67 is operatively connected to the unlocking button 7. The slider 67 is mounted in a tube body of the upper frame 81. The unlocking button 7 is mounted on the upper frame 81 so that the user can perform unlocking operation without bending over. Referring to FIG. 5, in some embodiments, the unlocking button 7 extends into the slider 67. The unlocking button 7 includes a first inclined surface 71, and the slider 67 includes a second inclined surface 671. The first inclined surface 71 and the second inclined surface 671 are in sliding fit. When the unlocking button 7 is pressed, the unlocking button 7 can move downwards while pushing the slider 67 to move in the tube body of the upper frame 81. The movement of the slider 67 is transmitted to the driving member 3 through the pulling member 6. The driving member 3 drives the locking member 2 to move towards the unlocked position after being subjected to the external force (more specifically, pulling force) from the pulling member 6. It should be understood that, the way of applying external force to the driving member 3 is not limited to the above examples. For example, in some alternative embodiments, the bearing portion 321 of the driving member 3 can directly extend out from the receiving cavity 110 for user operation, so that structures such as the pulling member 6 and the unlocking button 7 can be omitted. In addition, in some alternative embodiments, the bearing portion 321 may include an operating handle. The user can directly operate the operating handle manually to drive the driving member 3 to move. It should be noted that although the above embodiments are illustrated by taking the driving member 3 driving the locking member 2 to move to the unlocked position when being subjected to the pulling force as examples, in some alternative embodiments, the driving member 3 may drive the locking member 2 to move towards the unlocked position, when being subjected to a pushing force or a pressing force.

Referring again to FIG. 3, in some embodiments, the retaining member 4 is movably disposed on the vertical portion 11 of the body 1. The retaining member 4 is configured to lock the driving member 3, so as to retain the locking member 2 in the unlocked position when the driving member 3 drives the locking member 2 to move from the locked position to the releasing position. The retaining member 4 can be implemented in various ways. In some embodiments, the retaining member 4 can be telescopic relative to the body 1, and have an extended position and a retracted position. The moving direction of the retaining member 4 is parallel to the moving direction of the locking member 2. Referring to FIGS. 3, 6, and 7, in some embodiments, the cavity wall of the receiving cavity 110 is provided with a first hole 1101. The first hole 1101 is in communication with the first slot 101. The retaining member 4 enters the receiving cavity 110 through the opening 1100, and the retaining member 4 is movably disposed in the first hole 1101. When the connecting base 10 is separated from the mounting base 90, the retaining member 4 is in the extended position, and an abutting end 4a of the retaining member 4 extends into the first slot 101 relative to the first hole 1101, so as to be pressed by the mounting base 90. In some embodiments, a first channel wall 1111 is provided in the receiving cavity 110. The first channel wall 1111 is in slid fit with the retaining member 4. The first channel wall 1111 supports the retaining member 4 while guiding the telescoping of the retaining member 4. In some embodiments, the first channel wall 1111 and second channel wall 1121 may be partially overlapped.

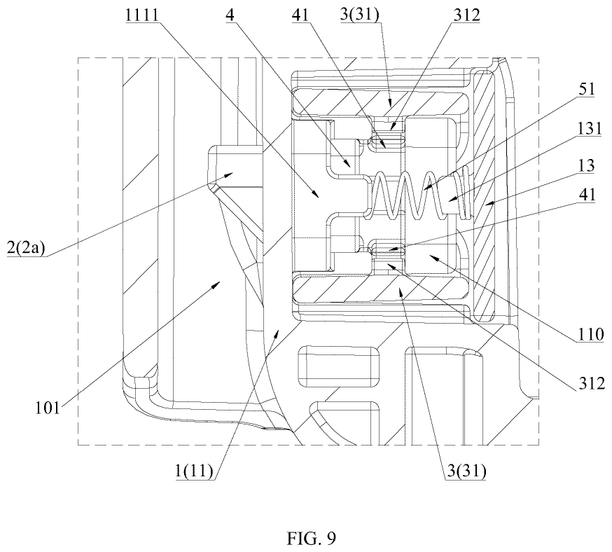

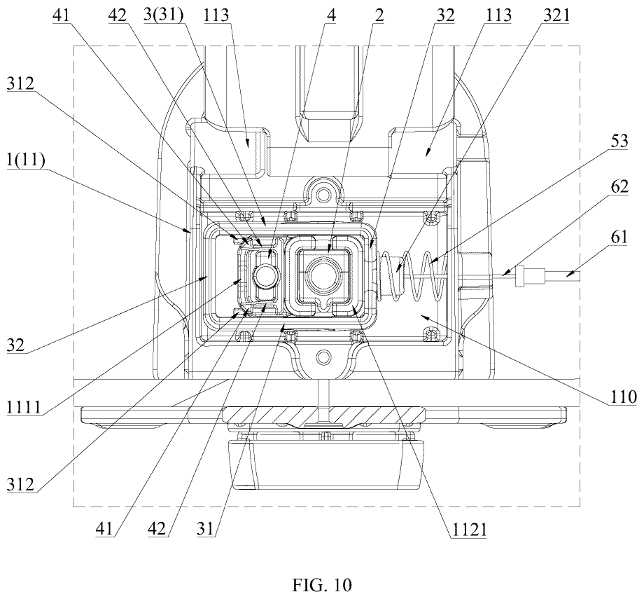

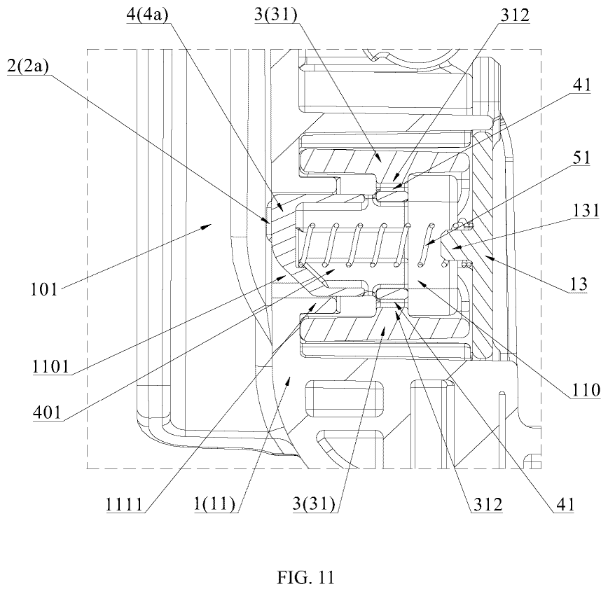

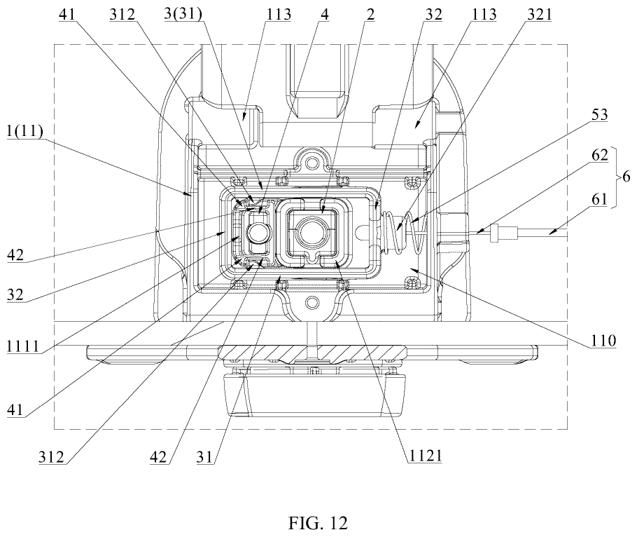

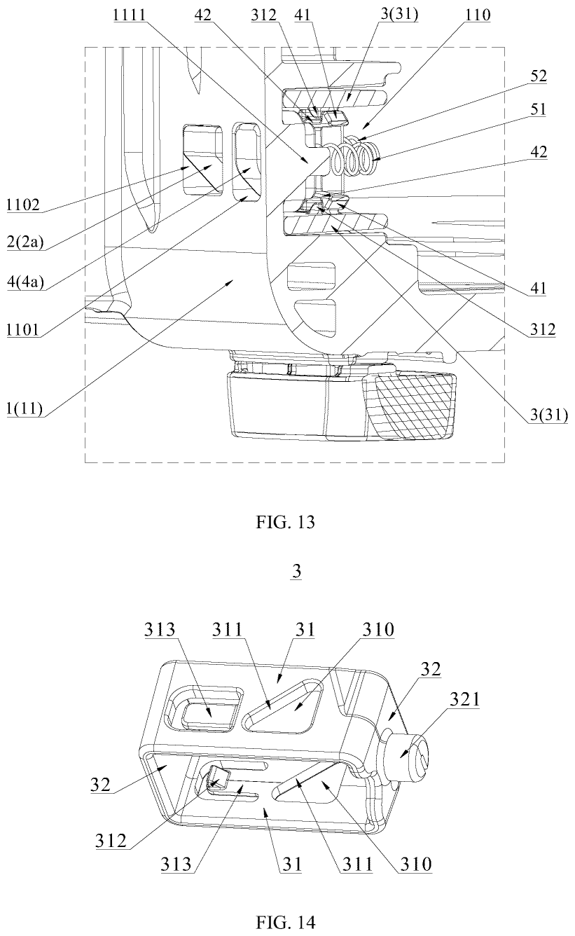

Referring to FIGS. 9 and 10, FIG. 9 is a partial cross-sectional view taken along a line C-C in FIG. 4, FIG. 10 is a rear view of the connecting base 10 in FIG. 4, that is, a right-side view of the connecting base 10 located on the left side in FIG. 2. For ease of illustration of an internal structure of the connecting base 10, the cover plate is omitted in FIG. 10. In FIGS. 9 and 10, the locking member 2 is in the locked position, the retaining member 4 is in the retracted position, and the driving member 3 is in an initial position. When the connecting base 10 is connected to the mounting base 90, the abutting end 4a of the retaining member 4 is pressed against by the mounting base 90 and moves to the retracted position (there is no hole disposed on the mounting base 90 corresponding to the retaining member 4), the locking member 2 is inserted into the locking hole 910. Referring to FIGS. 11 to 13, FIG. 11 is a partial cross-sectional view taken along a line D-D in FIG. 4, FIG. 12 is a rear view of the connecting base 10 in FIG. 4, that is, a right-side view of the connecting base 10 located on the left side in FIG. 2. For ease of illustration of an internal structure of the connecting base 10, the cover plate is omitted in FIG. 12. FIG. 13 is a cross-sectional perspective view taken along a line C-C in FIG. 4. In FIGS. 11 to 13, the locking member 2 is in the unlocked position, the retaining member 4 is in the retracted position, and the driving member 3 is in a position locked by the retaining member 4. After the connecting base 10 is connected to the mounting base 90, and the driving member 3 drives the locking member 2 to move from the locked position to the unlocked position, the retaining member 4 in the retracted position can prevent the driving member 3 from being reset to the initial position, thereby keeping the locking member 2 in the unlocked position.

More specifically, when it is necessary to remove the connecting base 10 from the mounting base 90, the unlocking force is applied to the driving member 3 by pressing the unlocking button 7. When the driving member 3 drives the locking member 2 to move from the locked position to the unlocked position, the retaining member 4 in the retracted position can be engaged with the driving member 3 to lock the position of the driving member 3. In this case, even if the unlocking button 7 is released, the driving member 3 is not reset to the initial position due to the blocking of the retaining member 4, and the locking member 2 is retained in the unlocked position. In this case, the user can lift the carrying device 100 without keeping pressing the unlocking button 7, so that the connecting base 10 is separated from the mounting base 90. By disposing the retaining member 4, when removing the carrying device 100, the user does not need to consider the synchronization of pressing the unlocking button 7 and lifting the carrying device 100, but only needs to press the unlocking button 7 and lift the carrying device 100 step by step, which greatly improves the convenience of the operation of removing the carrying device 100.

It can be understood that when the connecting base 10 is separated from the mounting base 90, the retaining member 4 is no longer pressed by the mounting base 90, and the retaining member 4 can move towards the extended position under the action of a first reset member 51, and be disengaged from the driving member 3, that is, the retaining member 4 in the extended position no longer blocks the movement of the driving member 3. In this case, the driving member 3 can be reset to the initial position under the action of a third reset member 53, the locking member 2 can move to the locked position under the action of the second reset member 52, and the connecting base 10 can be connected to the mounting base 90 again, and the relative position of the connecting base 10 and the mounting base 90 is locked by the locking member 2.

Continuing to refer to FIG. 3, an exemplary connecting structure of the driving member 3 and the retaining member 4 is shown. The retaining member 4 is located in the frame-shaped structure of the driving member 3. The retaining member 4 includes at least one first engaging portion 41. The first engaging portion 41 can be an engaging block or a hook. The driving member 3 includes at least one second engaging portion 312. The second engaging portion 312 can be an engaging block or a boss. When the first engaging portion 41 is engaged with the second engaging portion 312, the driving member 3 is locked. More specifically, in some embodiments, at least one second engaging portion 312 is disposed on each of the two first side plates 31 of the driving member 3. The retaining member 4 includes at least two first engaging portions 41. One of the at least two first engaging portions 41 is engaged with the second engaging portion 312 on one of the first side plates 31, and another one of the at least two first engaging portions 41 is engaged with the second engaging portion 312 on the other of the first side plates 31. When the retaining member 4 is in the retracted position and the locking member 2 is in the locked position, each of first engaging portions 41 moves onto a moving path of the corresponding second engaging portion 312. When the retaining member 4 is in the retracted position and the driving member 3 drives the locking member 2 to move towards the unlocked position, each of the second engaging portions 312 passes over the corresponding first engaging portion 41 and then is engaged with the first engaging portion 41. The position of the driving member 3 is locked by the retaining member 4, and the locking member 2 is retained in the unlocked position. When the retaining member 4 is no longer pressed by the mounting base 90 and moves from the retracted position to the extended position, each of the first engaging portions 41 moves out of the moving path of the corresponding second engaging portion 312, and the driving member 3 is reset to the initial position under the action of the third reset member 53, and the locking member 2 moves to the locked position under the action of the second reset member 52.

Referring again to FIG. 3, in some embodiments, the retaining member 4 includes at least one first elastic arm 42. At least one first engaging portion 41 is disposed on the at least one first elastic arm 42. In this way, when each of the second engaging portion 312 passes over the corresponding first engaging portion 41, the first elastic arm 42 can be elastically deformed, thereby reducing the resistance encountered by the second engaging portion 312 when passing over the first engaging portion 41. Referring to FIG. 14, in some alternative embodiments, the driving member 3 includes at least one second elastic arm 313. The at least one second engaging portion 312 is disposed on the at least one second elastic arm 313. The second elastic arm 313 can be elastically deformed, and can also reduce the resistance encountered by the second engaging portion 312 when passing over the first engaging portion 41. In some embodiments, the retaining member 4 may be provided with a stopper 43. The stopper 43 is located in the receiving cavity 110 and is used to prevent the retaining member 4 from falling out from the first hole 1101. For example, the stopper 43 is disposed on each of the first elastic arms 42. The stopper 43 and the first engaging portion 41 can be located at both ends of the corresponding first elastic arm 42.

Referring to FIG. 3, the connecting base 10 can further be provided with a first reset member 51. The first reset member 51 is configured to drive the retaining member 4 to move to the extended position. In some embodiments, the first reset member 51 may be a spring mounted in the receiving cavity 110. The first reset member 51 may be clamped between the retaining member 4 and the cover plate 13. In order to facilitate the fixation of the first reset member 51, a positioning hole 401 is disposed in the retaining member 4, and a positioning post 131 is disposed on the cover plate 13 (see FIG. 6). One end of the first reset member 51 extends into the positioning hole 401, the other end of the first reset member 51 is sleeved on the positioning post 131. In some alternative embodiments, the first reset member 51 can be implemented in many ways, as long as it can directly or indirectly act on the retaining member 4 to exert a force to move the retaining member 4 towards the extended position.

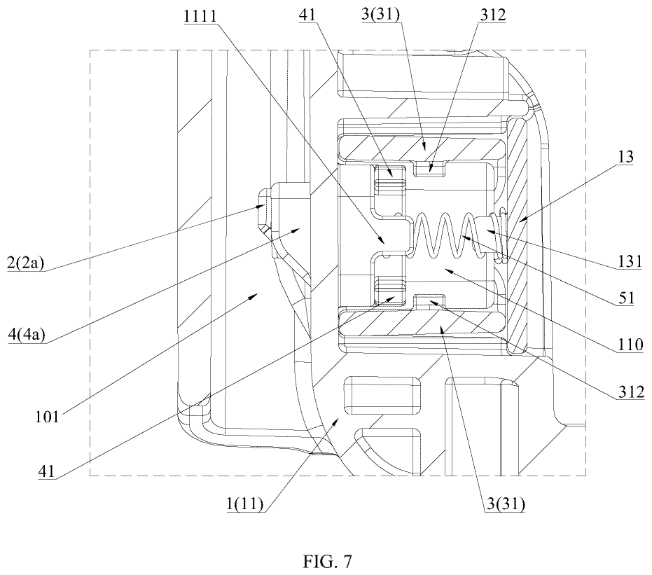

The mounting process and removing process of the connecting base 10 of the carrying device 100 will be briefly described below with reference to FIGS. 7 to 12.

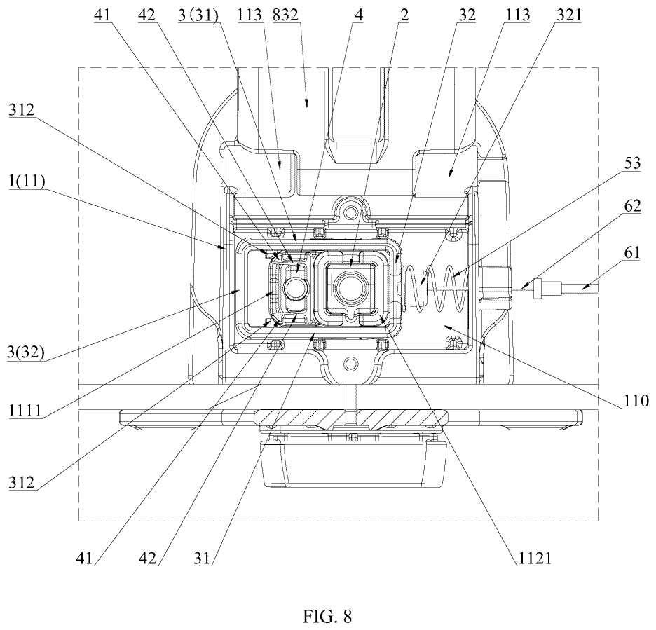

Referring to FIGS. 7 and 8, before the connecting base 10 is mounted on the mounting base 90, both the locking member 2 and the retaining member 4 extend into the first slot 101. At that time, the locking member 2 is in the locked position, and the retaining member 4 is in the extended position, and the driving member 3 is in the initial position under the action of the third reset member 53. In the moving direction of the retaining member 4, the first engaging portion 41 is offset from the second engaging portion 312.

Referring to FIGS. 9 and 10, after the connecting base 10 is connected to the mounting base 90, the locking member 2 is in the locked position and is connected to the locking hole 910 on the mounting base 90. The driving member 3 is in the initial position under the action of the third reset member 53. Since the position of the mounting base 90 corresponding to the retaining member 4 is not provided with a hole, the retaining member 4 is pressed by the mounting base 90 and retracts into the receiving cavity 110. The retaining member 4 moves to the retracted position, and the first engaging portion 41 moves to the moving path of the second engaging portion 312.

Referring to FIGS. 11 to 13, when it is necessary to remove the connecting base 10 from the mounting base 90, the driving member 3 is pulled by the pulling member 6, and the driving member 3 drives the locking member 2 to move to the unlocked position. At the same time, the second engaging portion 312 of the driving member 3 passes over the first engaging portion 41 and then is engaged with the first engaging portion 41. Then, the force exerted by the pulling member 6 on the driving member 3 is removed, the first engaging portion 41 and the second engaging portion 312 remain engaged with each other, thus preventing the driving member 3 from being reset to the initial position, and the driving member 3 is locked by the retaining member 4, the locking member 2 is retained in the unlocked position. The user can lift the carrying device 100 and remove the connecting base 10 from the mounting base 90.

After the connecting base 10 is removed from the mounting base 90, as not pressed by the mounting base 90, the retaining member 4 will extend into the first slot 101 under the action of the first reset member 51. The retaining member 4 moves to the extended position, the first engaging portion 41 is offset from the second engaging portion 312 in the moving direction of the retaining member 4, and the retaining member 4 no longer affects the movement of the driving member 3. The driving member 3 is reset to the initial position under the action of the third reset member 53, the locking member 2 moves to the locked position under the action of the second reset member 52, and the connecting base 10 is reset to a state shown in FIGS. 7 and 8.

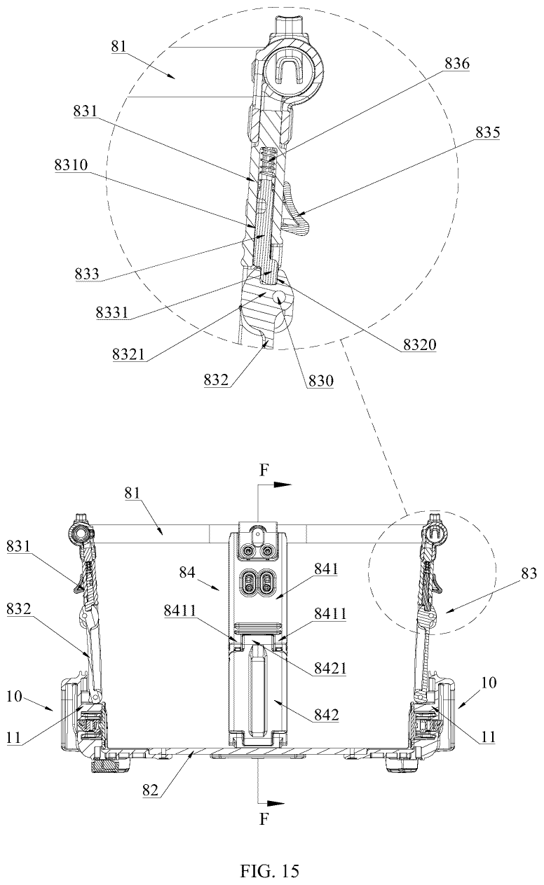

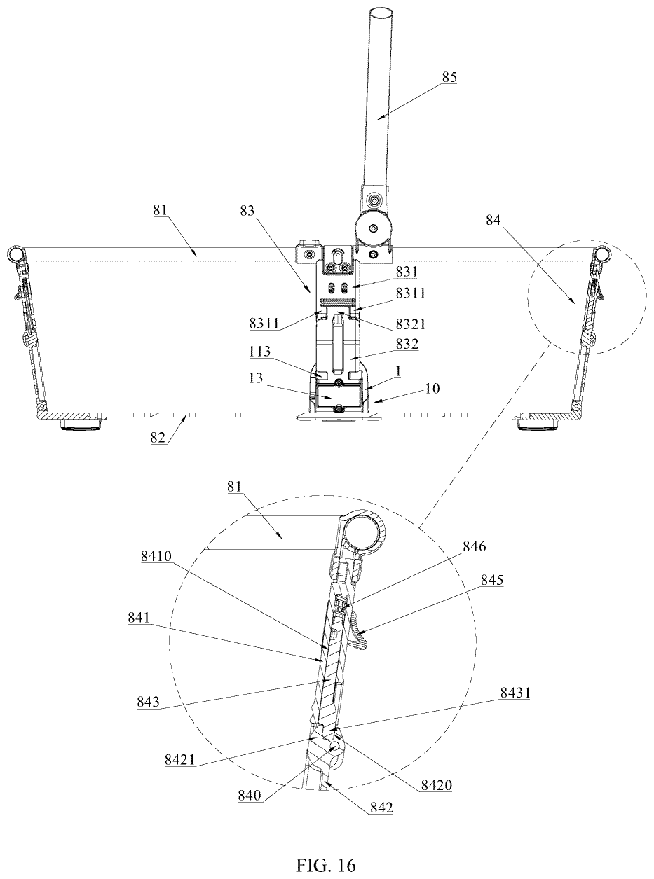

Referring to FIGS. 15 and 16, an exemplary structure of the first foldable mechanism 83 is shown. The implementation of the first foldable mechanism 83 is not limited to the following examples. The first foldable mechanism 83 includes a first upper bracket 831 and a first lower bracket 832. An upper end of the first upper bracket 831 is connected to the upper frame 81, and a lower end of the first upper bracket 831 includes two first lugs 8311. An upper end of the first lower bracket 832 includes a second lug 8321. The second lug 8321 is located between the two first lugs 8311. A first pivot shaft 830 extends through the first lugs 8311 and the second lug 8321, so that the first upper bracket 831 is pivotally connected to the first lower bracket 832. The lower end of the first lower bracket 832 is pivotally connected to the lower frame 82 directly or indirectly. In some embodiments, a pivot base 113 is disposed on the body 1 of the connecting base 10, and the lower end of the first lower bracket 832 is pivotally connected to the pivot base 113.

A second slot 8320 are disposed at the second lug 8321 of the first lower bracket 832. The first upper bracket 831 is provided with a first sliding channel 8310. A first inserting plate 833 and a first elastic member 836 are disposed in the first sliding channel 8310. The first elastic member 836 is configured to push a lower end 8331 of the first inserting plate 833 to be inserted into the second slot 8320. When the lower end 8331 of the first inserting plate 833 is inserted into the second slot 8320, the relative rotation of the first upper bracket 831 and the first lower bracket 832 is restricted, and the first foldable mechanism 83 is maintained in the unfolded state. A handle 835 is disposed on the first inserting plate 833. By operating the handle 835, the user can retract the lower end 8331 of the first inserting plate 833 from the second slot 8320. Then, the first upper bracket 831 and the first lower bracket 832 can rotate relative to each other, and the first foldable mechanism 83 can be folded.

Continuing to refer to FIGS. 15 and 16, an exemplary structure of the second foldable mechanism 84 is shown. The implementation of the second foldable mechanism 84 is not limited to the following examples. The second foldable mechanism 84 has substantially the same structure as that of the above-mentioned first foldable mechanism 83. The second foldable mechanism 84 includes a second upper bracket 841 and a second lower bracket 842. An upper end of the second upper bracket 841 is connected to the upper frame 81, and a lower end of the second upper bracket 841 includes two third lugs 8411. An upper end of the second lower bracket 842 includes a fourth lug 8421. The fourth lug 8421 is located between the two third lugs 8411. A second pivot shaft 840 extends through the third lugs 8411 and the fourth lug 8421, so that the second upper bracket 841 is pivotally connected to the second lower bracket 842. The lower end of the second lower bracket 842 is pivotally connected to the lower frame 82 directly or indirectly.

A third slot 8420 are disposed at the fourth lug 8421 of the second lower bracket 842. The second upper bracket 841 is provided with a second sliding channel 8410. A second inserting plate 843 and a second elastic member 846 are disposed in the second sliding channel 8410. The second elastic member 846 is configured to push a lower end 8431 of the second inserting plate 843 to be inserted into the third slot 8420. When the lower end 8431 of the second inserting plate 843 is inserted into the third slot 8420, the relative rotation of the second upper bracket 841 and the second lower bracket 842 is restricted, and the second foldable mechanism 84 is maintained in the unfolded state. A handle 845 is disposed on the second inserting plate 843. By operating the handle 845, the user can retract the lower end 8431 of the second inserting plate 843 from the third slot 8420. Then, the second upper bracket 841 and the second lower bracket 842 can rotate relative to each other, and the second foldable mechanism 84 can be folded.

The technical features of the embodiments above may be combined arbitrarily. To make the description concise, not all possible combinations of the technical features in the above embodiments are described. However, as long as there are no contradictions in the combinations of these technical features, all of the combinations should be considered to be within the scope of the specification.

The embodiments above only represent several implementation modes of the present disclosure, and the description thereof is relatively specific and detailed, but it should not be construed as limiting the scope of the patent. It should be noted that for those skilled in the art, various modifications and improvements may be made without departing from the concept of the present disclosure, and all these modifications and improvements fall within the protection scope of the present disclosure. Therefore, the scope of protection of the present disclosure shall be subject to the appended claims.

1. A connecting base, comprising:
a body; and
a locking member mounted on the body, the locking member having a locked position and an unlocked position;
a driving member mounted on the body and connected to the locking member, and the driving member being configured to drive the locking member to move from the locked position to the unlocked position; and
a retaining member mounted on the body,
wherein when the locking member moves to the unlocked position, the retaining member is configured to lock the driving member, so as to retain the locking member in the unlocked position, and
wherein the retaining member is movably disposed on the body and has an extended position and a retracted position; when the retaining member is in the retracted position, and the locking member moves from the locked position to the unlocked position, the retaining member is engaged with the driving member to lock the driving member; and when the retaining member moves towards the extended position, the retaining member is disengaged from the driving member.

2. (canceled)

3. The connecting base according to claim 1, further comprising a first reset member configured to drive the retaining member to move towards the extended position.

4. The connecting base according to claim 1, wherein the locking member is movable relative to the body between the locked position and the unlocked position; and a moving direction of the locking member is parallel to a moving direction of the retaining member.

5. The connecting base according to claim 1, further comprising a second reset member configured to drive the locking member to move towards the locked position.

6. The connecting base according to claim 1, further comprising a third reset member configured to drive the driving member to reset when the retaining member is disengaged from the driving member.

7. The connecting base according to claim 1, wherein the body comprises a receiving cavity in which the driving member is mounted, wherein a cavity wall of the receiving cavity is provided with a first hole and a second hole; the retaining member is movably disposed in the first hole; the locking member is movably disposed in the second hole; a moving direction of the locking member is parallel to a moving direction of the retaining member; and the moving direction of the locking member is perpendicular to a moving direction of the driving member.

8. The connecting base according to claim 7, wherein a driven pin is mounted on the locking member; an axial direction of the driven pin, the moving direction of the locking member, and the moving direction of the driving member are perpendicular to one another; the driving member comprises at least one driving slope, wherein the driving slope abuts against the driven pin to drive the locking member to move from the locked position to the unlocked position.

9. The connecting base according to claim 8, wherein the driving member has a frame-shaped structure; the retaining member and the locking member are located in the frame-shaped structure, wherein the frame-shaped structure comprises two opposite side plates; each side plate is provided with a driving hole; and the driving slope is formed on a hole wall of each driving hole.

10. The connecting base according to claim 7, wherein the driving member comprises a bearing portion extending out of the receiving cavity.

11. The connecting base according to claim 7, wherein the retaining member is provided with a stopper located in the receiving cavity.

12. The connecting base according to claim 1, wherein a moving direction of the retaining member is perpendicular to a moving direction of the driving member; the retaining member comprises at least one first engaging portion; the driving member comprises at least one second engaging portion;
when the retaining member is in the retracted position and the locking member is in the locked position, each of the at least one first engaging portion moves onto a moving path of the corresponding second engaging portion.

13. The connecting base according to claim 12, wherein when the retaining member is in the retracted position and the driving member drives the locking member to move towards the unlocked position, each of the at least one second engaging portion passes over the corresponding first engaging portion and then is engaged with the first engaging portion.

14. The connecting base according to claim 13, wherein when the retaining member moves from the retracted position to the extended position, each of the at least one first engaging portion moves out of the moving path of the corresponding second engaging portion.

15. The connecting base according to claim 12, wherein the driving member comprises two opposite side plates; the at least one second engaging portion is disposed on each side plate; the retaining member is located between the two side plates; the retaining member comprises at least two first engaging portions; wherein one of the at least two first engaging portions is engaged with the second engaging portion on one of the two side plates, and the other one of the at least two first engaging portions is engaged with the second engaging portion on the other of the two side plates.

16. The connecting base according to claim 12, wherein the retaining member comprises at least one first elastic arm; and the at least one first engaging portion is disposed on the at least one first elastic arm.

17. The connecting base according to claim 12, wherein the driving member comprises at least one second elastic arm;
and the at least one second engaging portion is disposed on the at least one second elastic arm.

18. A carrying device, comprising:
the connecting base according to claim 1;
a pulling member; and
an unlocking button connected to the driving member through the pulling member.

19. (canceled)

20. The carrying device according to claim 18, further comprising:
an upper frame;
a lower frame; and
a foldable mechanism connected between the upper frame and the lower frame,
wherein the foldable mechanism is capable of being unfolded to enable the upper frame and the lower frame to move away from each other; and the foldable mechanism is capable of being folded to enable the upper frame and the lower frame to approach each other.

21. The carrying device according to claim 20, wherein the foldable mechanism comprises:
a first upper bracket, an upper end of the first upper bracket being connected to the upper frame, and a lower end of the first upper bracket comprising two first lugs;
a first lower bracket, an upper end of the first lower bracket comprising a second lug located between the two first lugs, and a lower end of the first lower bracket being pivotally connected to the lower frame; and
a first pivot shaft extending through the first lugs and the second lug to enable the first upper bracket to be pivotally connected to the first lower bracket.

22. A child carrier, comprising:
a main frame comprising a mounting base; and
the carrying device according to claim 18,
wherein the mounting base is removably connected to the connecting base; and the mounting base is provided with a locking hole corresponding to the locking member.
